(19) United States
(12) Patent Application Publication
(10) Pub. No.: US 2026/0050101 A1
(43) Pub. Date: Feb. 19, 2026

(54) Metal Detector Coil

(71) Applicant: Minelab Electronics Pty. Limited, Mawson Lakes (AU)

(72) Inventors: Nicholas Luke Schultz, Mawson Lakes (AU); Philip Shane Wahrlich, Mawson Lakes (AU)

(21) Appl. No.: 19/302,164

(22) Filed: Aug. 18, 2025

(30) Foreign Application Priority Data
Aug. 19, 2024 (AU) 2024902580

(51) Int. Cl. G01V 3/10; G01V 3/165

(52) U.S. Cl. CPC G01V 3/104; G01V 3/165

(57) ABSTRACT

A coil of a handheld metal detector, including at least three windings, including at least one transmit winding and at least one receive winding, the at least one transmit winding for transmitting a transmit magnetic field; and the at least one receive winding for receiving a receive magnetic field; wherein the at least three windings are configured and arranged such that primary planes of each of the at least three windings are substantially co-planar, the at least three windings are electrically separated, and the at least three windings are inductively balanced to one another.

### CROSS-REFERENCE TO RELATED APPLICATIONS

This application claims priority to Australian Patent Application No. 2024902580 filed Aug. 19, 2024, the disclosure of which is hereby incorporated by reference in its entirety.

### BACKGROUND

### Field

The present disclosure relates to a metal detector coil.

### Description of Related Art

The general forms of most metal detectors that interrogate soil are either handheld battery-operated units, conveyor-mounted units, or vehicle-mounted units. Examples of handheld products include detectors used to locate gold; explosive land mines or ordnance; or coins and treasure. Examples of conveyor-mounted units include tramp metal detectors used in ore mining operations, and examples of a vehicle-mounted unit include a unit to locate buried land mines.

A typical metal detector comprises a magnetic antenna which comprises a magnetic field transmitter and a magnetic field receiver, to transmit a transmit magnetic field and to receive a receive magnetic field, respectively. Within the hand-held metal detector industry, magnetic antennae are known as “coils”. Most comprise inductive windings that act to transmit time-changing magnetic fields and to receive time-changing magnetic fields. These windings are typically housed within a coil housing, such as a plastic coil housing. The metal detector usually, but not necessarily, includes transmit electronics generating a repeating transmit signal cycle of a fundamental period, which is applied to a transmit winding to transmit the transmit magnetic field.

The metal detector may also include receive electronics connected to a receive winding. The receive electronics processes a receive signal from a measured receive magnetic field, during one or more receive periods during the repeating transmit signal cycle, to produce an indicator output signal, the indicator output signal at least indicating the presence of at least a metal target within the influence of the transmit magnetic field.

A winding is usually made of multi-turn wires. For example, a monoloop transmit winding for a metal detector usually refers to a transmitter formed by winding wires multiple times following the contour of a same loop to form a single loop. Windings may refer to various types of windings or a group of windings.

During the processing of the receive signal, the receive signal may be sampled or demodulated, to produce one or more target channels, the one or more target channels may be further processed to produce the indicator output signal.

Sometimes a particular winding can be used as both a transmit winding and a receive winding. This is typically the case in monoloop coils used with pulse induction metal detectors, wherein a single winding is used during a first time period to transmit a time-varying magnetic field then the same winding is used during a second time period to receive a time-varying magnetic field. A winding may consist of multiple windings connected in series. This is the case in concentric coils which typically use two counter-wound receive windings connected in series or two counter-wound transmit windings connected in series. The transmit and receive windings are housed within a coil housing, with the entire assembly typically referred to as a coil, search coil or sensor head, where some or all of the electronics are attached to the coil via an electrical cable and/or wirelessly connected to an external control source. Some coils contain preamplifiers within their coil housing.

Metal detectors can be broadly categorised into either time-domain or frequency-domain metal detectors. Time-domain metal detectors are metal detectors that typically have transmit and receive time periods, which may be temporally overlapping, within each detection cycle. Frequency-domain, also referred to as continuous wave, refers to detectors that simultaneously transmit and receive signals, and analyse the receive signals in the frequency domain. Frequency-domain detectors have an advantage over time-domain detectors when detecting very small, high-frequency targets, and in discrimination of targets by their electromagnetic properties. Frequency-domain detectors usually contain windings that are arranged geometrically such that the net voltage induced in the receive winding by the transmit windings is zero, commonly referred to as nulled or induction balanced.

To minimise coil weight, and maintain high detection sensitivity, it is important to place the transmit and receive windings near to and in many cases overlapping one another. This allows the total combined area of the windings within the coil to be similar to the overall coil size, which is beneficial for detection sensitivity. However, the proximity of the windings increases coupling between them. This can generate crosstalk between windings. To address this, specific geometric arrangements that are induction balanced are advantageous in handheld applications. An induction balanced arrangement allows two windings to be located closer together than would otherwise be possible while maintaining an effective zero magnetic coupling between the windings. It is possible to reduce the magnetic coupling between windings by spacing them sufficiently far apart, however with this approach the magnetic coupling merely asymptotes toward zero as the spacing is increased, never achieving a zero-coupling state. Comparatively, for a given acceptably small magnetic coupling, an induction balanced arrangement will typically be a spatially more compact winding arrangement.

Many metal detector coils are constructed using a single transmit winding and a single receive winding, arranged such that they are induction balanced. This arrangement allows for simultaneous transmitting and receiving. Additionally, some metal detector coils are constructed with more than one transmit or receive winding, where multiple transmit or receive windings are connected in series to permit alternative geometries that are also induction balanced. In all these examples, there is a single transmit circuit and a single receive circuit. Windings of this nature are most common in handheld applications.

It is generally advantageous for the coil to be designed such that the depth of detection of targets of interest is as great as practically achievable in order to afford an increased chance that a deep-buried object will be detectable. Coils that are available for public sale are therefore predominantly those where the transmit magnetic field decreases slowly with distance from the coil and similarly the receive coil sensitivity pattern also decreases slowly with distance from the coil. A simple current-carrying circular loop will produce a magnetic field B_{z} in the z-direction (normal to the loop plane) along the centreline of the loop given as

$${B}_{z} = \frac{{μ}_{0} I}{2} \frac{{R}^{2}}{{( {z}^{2} + {R}^{2} )}^{3 / 2}}$$

where μ₀ is the permeability of free space, I is the current through the loop, R is the radius of the loop, and z is the distance from the loop along the centreline of the loop. When z is large in comparison to R, it can be seen that B_{z} decreases as the third power of z. This behaviour is typical of metal detector coils currently for sale. Other coil configurations are known, such as a figure-8 winding, which yields a magnetic field that decreases more rapidly than the third power of z for large values of z in comparison to R, which is undesirable for detecting deep-buried metallic objects as the response generated by deep-buried metallic objects becomes very small.

In further examples, the metal detector coil is constructed with multiple transmit or receive windings, connected individually to multiple transmit or receive electronic circuits. In general, the response from a target depends on the location and orientation of the target relative to the transmit winding and the receive winding. Employing multiple transmit or multiple receive windings therefore provides different measurements of a target or an arrangement of multiple targets. These different measurements can be used to estimate or determine properties of the target or multiple targets such as the identity, location, depth, or orientation relative to the coil. Windings of this nature are most common in vehicle mounted applications or static installations in security applications.

Present examples of metal detector coils with multiple independent receive windings typically take one of two forms. In one form, the windings are arranged orthogonal to one another. This allows for up to three windings to easily be mutually induction balanced but results in a substantially increased coil assembly height. This form also presents some limitations in detection performance such as reduced depth compared to co-planar windings, and increased susceptibility to electromagnetic interference from the environment. The orthogonal winding arrangement also limits the sensitivity pattern of the coil, further constraining the utility of such a coil. In the second form, multiple receive windings are arranged substantially co-planar with the transmit winding but are not induction balanced to each other. There may be inductive crosstalk between receiver windings. When a voltage is induced in one receive winding, current flows in the receive winding which creates a magnetic field that can induce voltages in nearby magnetically coupled receive windings. These crosstalk signals are typically much smaller in magnitude and phase-shifted relative to the primary signal and can generate false alarms in the metal detector. The reactive response from the soil is generally much larger in magnitude than the response from the deepest metallic target of interest. This large reactive response can generate substantial crosstalk signals in magnetically coupled receive windings that can be mistaken for metallic targets of interest. Such winding arrangements are typically limited to use in time-domain detectors, or in frequency-domain detectors with performance limited by the unwanted voltages induced between receive windings.

There are examples of such arrays of windings used to determine target properties in the literature.

U.S. Pat. No. 5,721,489A uses one transmit winding and two receive windings to estimate both the depth and approximate size of the target. U.S. Pat. No. 5,721,489A only describes that the two receive windings may be inductively balanced with respect to the transmit winding in a co-planar arrangement or near co-planar arrangement.

U.S. Pat. No. 11,232,700B2 describes a personal inspection system including a plurality of magnetic field receivers sensing magnetic fields at two frequency components, a first frequency component between 100 Hz and 1000 Hz and a second frequency component between 5 Hz and 100 Hz. U.S. Pat. No. 11,232,700B2 describes determining a polarisability index associated with a target, which may include a complex symmetric tensor, based on testing a set of trial solutions and selecting the trial solution which best fits the magnetic field samples. U.S. Pat. No. 11,232,700B2 describes three transmit windings arranged orthogonally, and two transmit windings with the same orientation but offset in space. In particular, the two transmit windings can be configured to operate simultaneously by operating on different frequencies. Separately, U.S. Pat. No. 11,232,700B2 also describes a plurality of receivers, in particular two-and three-axis flux-gate magnetometers, which are sensitive to a first magnetic field generated by transmit windings.

U.S. Pat. No. 7,391,217B2 describes an array of windings that may be combined in various configurations to produce a receive signal but does not describe a means to achieve an induction balanced arrangement of windings.

For handheld metal detector coils, there are tighter constraints on weight and form factor than those, for example, for a vehicle mounted system. Minimising coil weight is important for operator comfort during use. As the coil is typically suspended at the end of a pole, it requires significant torque from the operator's arm to suspend the coil off the ground statically and also to move the coil dynamically during use. Maintaining a low height is also important for a handheld metal detector coil to permit easy movement through water, for manoeuvring around obstacles, and for general storage reasons. Minimising overall coil height will also generally improve manufacturability and cost of manufacture.

It is common for arrays of transmit windings and receive windings to have the receive windings configured such that each receive winding is induction balanced with respect to a transmit winding. Arrays of transmit windings and receive windings configured such that all windings are induction balanced with respect to each other by utilising orthogonal arrangements of windings are known. However, in such arrangements, the windings are not co-planar.

The present disclosure presents an alternative metal detector coil against the background.

### SUMMARY

According to a first aspect of the present disclosure, there is provided a coil of a handheld metal detector, comprising: at least three windings, comprising at least one transmit winding and at least one receive winding, the at least one transmit winding for transmitting a transmit magnetic field; and the at least one receive winding for receiving a receive magnetic field; wherein the at least three windings are configured and arranged such that primary planes of each of the at least three windings are substantially co-planar, the at least three windings are electrically separated, and the at least three windings are inductively balanced to one another.

In one form, the at least one receive winding comprises a multi-turn monoloop winding, with the multi-turn monoloop winding occupying at least 90% of the at least one receive winding in terms of coil area.

In one form, a main lobe of a magnetic field pattern of the at least one receive winding decreases less rapidly than or equal to a third power of a distance along an axis normal to a plane of the at least one receive winding at a distance equal to a size of a largest dimension of the at least one receive winding.

In one form, each of the at least three windings is configured and arranged such that magnetic crosstalk between any two of the at least three windings is minimised to <10%.

In one form, each of the at least three windings overlaps with each of the other windings.

In one form, all of the at least three windings encircle a common point.

In one form, each of two of the at least three windings has a bucking winding connected in series, and the bucking windings are coupled to each other. In one form, the bucking windings are figure-8 windings.

In one form, outer perimeters of the at least three windings form a substantially circular or elliptical shape.

In one form, the at least three windings comprise two receive windings and one transmit winding.

In one form, the at least three windings comprise one receive winding and multiple transmit windings. In one form, the multiple transmit windings are transmitting different transmit waveforms. In one form, the different transmit waveforms differ in their spectral content. In one form, the different transmit waveforms are transmitted at different times.

In one form, a combined height of the at least three windings is less than 50 mm.

According to another aspect of the present disclosure, there is provided a handheld metal detector comprising a sensor head housing the coil of the first aspect.

### BRIEF DESCRIPTION OF THE DRAWINGS

Embodiments of the present invention will be discussed with reference to the accompanying drawings wherein:

FIG. 1 is a handheld metal detector with a sensor head;

FIG. 2 is a view of a three-winding arrangement according to an embodiment of the present disclosure;

FIG. 3 is a four-winding arrangement in which one central winding is surrounded by three other windings according to an embodiment of the present disclosure;

FIG. 4 is a non-axisymmetric variation of the four-winding shown in FIG. 3;

FIG. 5 is an alternative four-winding arrangement in which all windings encircle a common point according to an embodiment of the present disclosure;

FIG. 6 is a four-winding arrangement in which all windings encircle a common point according to an embodiment of the present disclosure;

FIG. 7 is a six-winding arrangement in which all windings encircle a common point according to an embodiment of the present disclosure; and

FIG. 8 shows yet another embodiment of the present disclosure.

### DETAILED DESCRIPTION

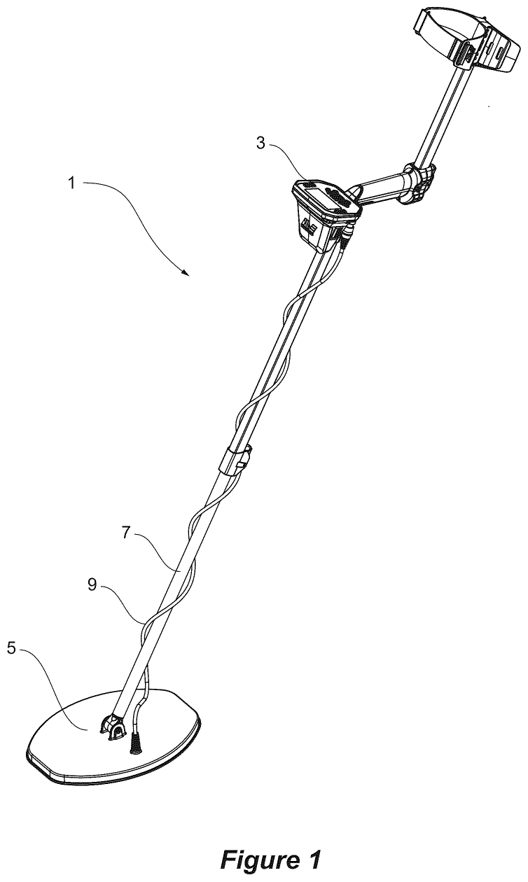

FIG. 1 depicts a handheld metal detector 1. The metal detector 1 comprises a processing unit 3 with user interface. The processing unit 3 is connected to a sensor head or coil housing 5 mounted on shaft 7 through a composite cable 9. The sensor head or coil housing 5 contains transmit winding and receive winding therein (not shown). Composite cable 9 usually comprises multiple independent cables, for example, one transmit cable for connecting the transmit winding to the transmit electronics in the processing unit 3, and another cable for connecting the receive winding to the receive electronics in the processing unit 3. Composite cable 9 may be replaced by wireless connection between the sensor head or coil housing 5 and processing unit 3.

A broad form of the present disclosure is about a coil of a handheld metal detector within the sensor head or coil housing 5. The coil comprises at least three windings, with at least one transmit winding and at least one receive winding. The at least one transmit winding is for transmitting a transmit magnetic field, and the at least one receive winding is for receiving a receive magnetic field. The at least three windings are configured and arranged such that primary planes of each of the at least three windings are substantially in a same plane, the at least three windings are electrically separated, and the at least three windings are inductively balanced to one another.

Each of the windings is electrically separated in which each of them is connected to processing unit 3 separately. They are not in series or anti-series or in parallel to one another or combined in electronics to behave as a single winding.

The winding assemblies are arranged geometrically to be mutually induction balanced, such that an electrical current in any of the winding assemblies does not induce any substantial voltage in any of the other winding assemblies. “Does not induce any substantial voltage” should be understood by a person skilled in the art to be <10% of fully coupled windings in this context. In one form, the present disclosure reduces <10% to <5%. In one form, the present disclosure reduces <10% to <1%.

All the winding assemblies are arranged in a substantially co-planar arrangement, such that the overall height of the windings at an operational orientation is less than 50 mm. In another form, the overall height is less than 30 mm. In one form, the overall height is less than 10 mm. “Substantially co-planar” does not require that the windings be exactly on the same plane or being exactly parallel to each other. There may be small offsets, bends, and tilts etc between any two of the windings.

The induction balance of the windings is achieved using geometric arrangement of the windings with respect to one another. In this arrangement, each winding is formed by a single loop of wire with one or more turns. The substantially co-planar windings each partially overlap one another such that they are induction balanced.

Each receive winding is with the main lobe of the magnetic field pattern decreasing less rapidly than or equal to a third power of the distance along the axis normal to the plane of the receive winding at a distance equal to the size of the largest dimension of the receive winding. This excludes for example, quadrupole windings like figure-8 windings etc, which have magnetic field patterns that decrease approximately as the fifth power of distance along the axis normal to the plane of the receive winding. The receive winding may be connected to bucking windings without substantially affecting the detection performance or sensitivity pattern of the winding. In one form, a receive winding comprises a multi-turn monoloop winding with a bucking winding, with the multi-turn monoloop winding occupying at least 90% of the receive winding in terms of coil area.

While two separate transmit and receive pairs enable determination of more target information than just a single transmit and receive pair, at least three separate transmit and receive pairs may enable determination of target information such as the three-dimensional location of a target with respect to the coil. Consider that the response associated with a target in each receive winding due to the signal transmitted by a transmit winding depends on the target location and orientation with respect to the windings as well as the coupling between the target and the windings as well as the electromagnetic properties of the target. If we set aside the determination of the electromagnetic properties of the target, which is generally addressed by multi-frequency spectral estimation, and target orientation, there are still three cartesian coordinates defining the target location and a coupling coefficient that can influence the response in a receive winding.

With a single measurement from one receive winding it is not possible to accurately estimate these four parameters. One can hope to estimate one of these parameters if we assume that the other three are known. Metal detectors estimate the depth of a detected target by assuming that the receive signal is measured when the target is beneath the centre of the coil, and that the target is coupled with the transmit and receive windings to a degree consistent with a typical coin-sized target. Essentially, this constrains two of the cartesian coordinates associated with the target location as well as constraining the target coupling as a function of distance from the coil so that this distance can be estimated.

It is known that with two receive windings, two parameters can be estimated under the assumption that two of the four unknown parameters are constrained. This is described in U.S. Pat. No. 5,721,489A, wherein the target size, which is related to the target coupling, is estimated alongside the target depth.

In a similar manner, further increasing the number of transmit and receive pairs, and utilising the additional measurements they provide, allows for the estimation of further parameters related to the target, such as the remaining cartesian coordinates defining the target location.

It may be beneficial to utilise the different signals from a set of unique combinations of transmit winding, transmit frequency, receive signal processing, and receive winding from the set of available transmit winding, transmit frequencies, and receive winding to measure the response from the target or arrangement of multiple targets. For brevity, the unique combinations of transmit winding, transmit frequency, receive signal processing, and receive winding are referred to as unique transceiver configurations.

In one form, the different signals from the unique transceiver configurations are each used to produce an indicator output that is indicative of the identity of the target in a similar manner as described in U.S. Pat. Nos. 8,729,902B1. 8,729,902B1 includes a description of displaying target identification information for each of a plurality of transmit frequencies. Similarly, it is beneficial to display target identification information for a plurality of unique transceiver configurations, including unique combinations of transmit windings and receive windings.

In one form, the different signals from the unique transceiver configurations are multi-frequency signals that are used to form a spectral vector subspace, for example, a configuration with one transmit winding and three receive windings. The transmit winding transmits four frequencies. The receive signals from the three receive windings are each demodulated at each of the four frequencies to produce three sets of eight signals, where each set of eight signals consists of four in-phase and quadrature pairs and originates from a transmit-receive pair. Considering each of the eight signals as a vector, the three sets of eight signals form a spectral vector subspace which is a subset of the larger eight-dimensional vector space. When there are two or three targets each contributing a unique spectral response to the signals, each of the three sets of eight signals is a linear combination of these unique spectral responses. Targets can be detected by testing whether their expected spectral response lies close to the spectral vector subspace.

In one form, there is one transmit winding and two receive windings. Both receive windings are arranged in an induction balanced configuration with respect to the transmit winding and with respect to each other. The two receive signals, one from each receive winding, are processed separately. Correspondingly two indicator outputs are produced, each associated with one of the two receive windings, wherein each indicator output is a visual target identification number. Additionally, a third indicator output is produced, which depends on the disparity between the two receive signals.

In one form, there are two transmit windings and a single receive winding. The two transmit windings are transmitting different transmit waveforms. In one form, the different transmit waveforms differ in their spectral content. In another form, the different transmit waveforms differ in their phase.

For example, the first transmit winding transmits a first two frequencies, and the second transmit winding transmits a second different two frequencies. The first two frequencies may be similar to the second two frequencies. The receive signal from the receive winding is demodulated at all four frequencies to produce four in-phase and quadrature pairs. Two of the four in-phase and quadrature pairs are associated with the first transmit winding and the remaining two of the four in-phase and quadrature pairs are associated with the second transmit winding. This essentially constitutes employing frequency-division multiplexing.

In one form, there are two transmit windings and a single receive winding. The first transmit winding transmits a first transmit waveform for a first short period of time less than 10 milliseconds then ceases transmitting. Then the second transmit winding transmits a second transmit waveform that may be the same as the first transmit waveform for a second short period of time less than 10 milliseconds then ceases transmitting. Then the cycle repeats, with the first transmit winding transmitting. In this case, the first transmit waveform and the second transmit waveform are different in terms of their phase. The receive winding demodulates the receive signal associated with each transmit winding separately. This essentially constitutes employing time-division multiplexing.

Further, magnetic crosstalk between receive windings may be mitigated by arranging the receive windings in an induction balanced arrangement as shown by various embodiments of the present disclosure.

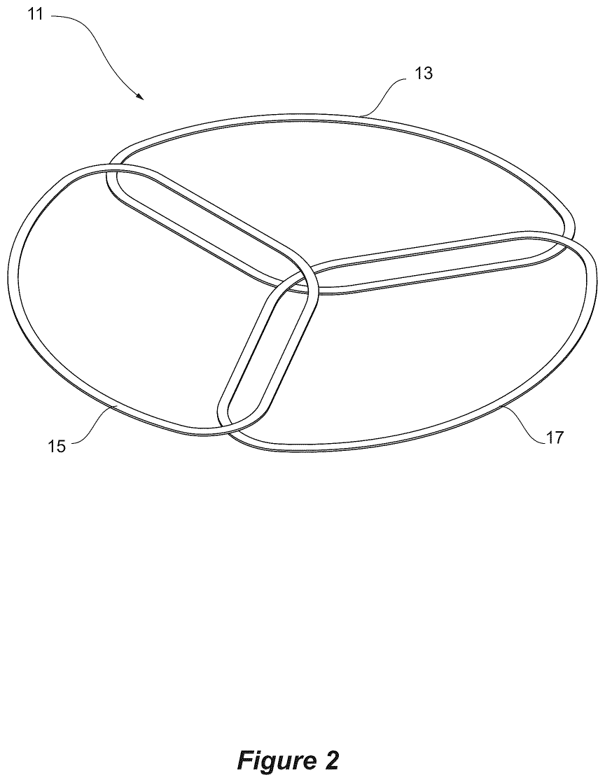

FIG. 2 shows one embodiment of the present disclosure. In this embodiment, the coil 11 has three windings 13, 15, 17 located substantially in one plane, wherein at least one winding is a transmitter and one winding is a receiver, with the third being a transmitter or receiver. The windings are nulled with respect to each other geometrically, using the overlapping areas. With reference to FIG. 2, it can be seen that the features of “located substantially in one plane” does not require that the windings are exactly in the same plane. Firstly, it only requires that the planes of each of the windings 13, 15, 17 are substantially parallel to each other, and secondly, that they are close to each other in that the overall height to width ratio is <10%.

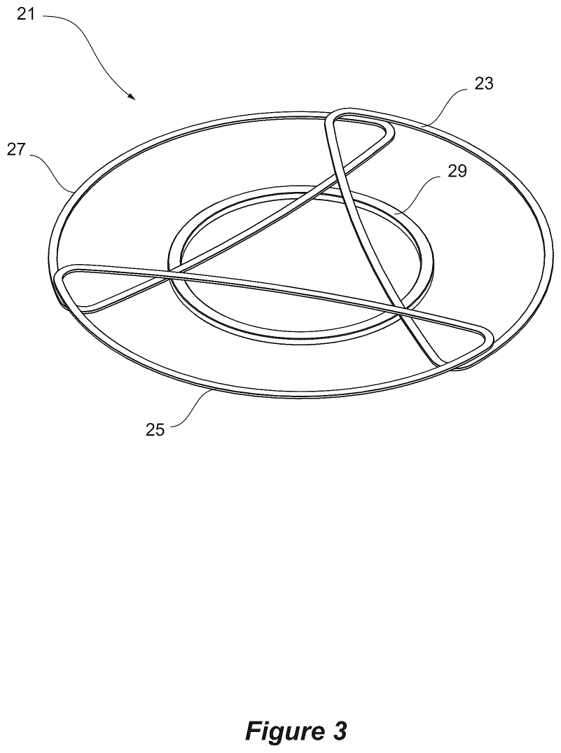

FIG. 3 shows that four or more windings 23, 25, 27, 29 may be geometrically nulled in a coil 21. In this embodiment, one central winding 29 is with three other windings 23, 25, 27 around it. FIG. 3. shows an axisymmetric arrangement, where a central winding 29 is surrounded by three identical windings 23, 25, 27 arranged at 120 degrees to each other. The outer three windings 23, 25, 27 are nulled with respect to each other with a largely tangential overlap, while the central winding 29 is nulled with respect to the outer windings 23, 25, 27 with a largely radial overlap. In one form, the winding 29 is the transmit winding with outer windings 23, 25, 27 being receive windings.

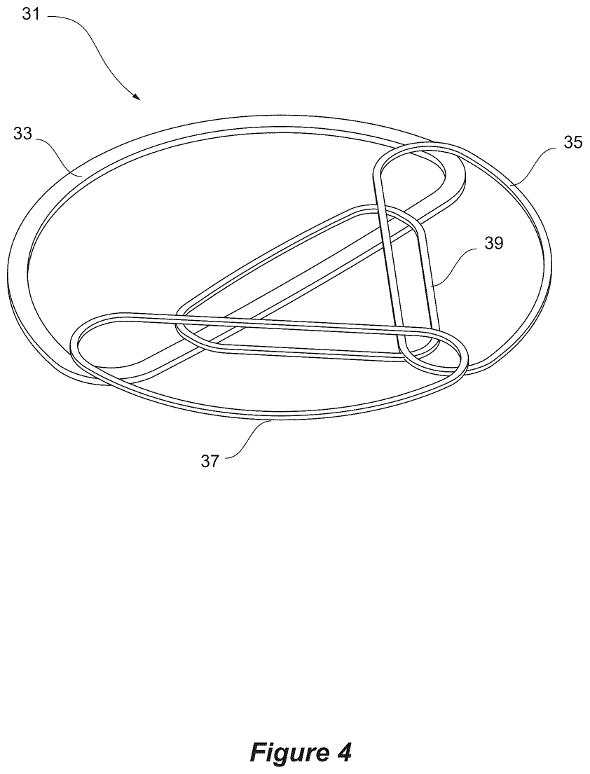

FIG. 4 shows an alternative form of a coil 31 where the windings 33, 35, 37, 39 are arranged non-axisymmetrically, with a transmit winding 33 on one side of the arrangement and three receive windings 35, 37, 39 on the opposite side of the arrangement.

For arrangements of windings wherein all windings are nulled with respect to each other, it should be obvious to those skilled in the art that any of the windings in such arrangements could be a transmitter or receiver, so long as there is at least one transmitter and one receiver in the assembly.

The embodiment shown in FIG. 4. is an arrangement that is quite similar to a standard single-transmit, single-receive winding configuration known as Double-D, where a transmit winding is located substantially in one half of the coil, and a receive winding is located in the other half of the coil. The transmit and receive windings overlap down the centre of the coil, typically in an elongated blade shape that gives the coil strong target sensitivity in this overlap area.

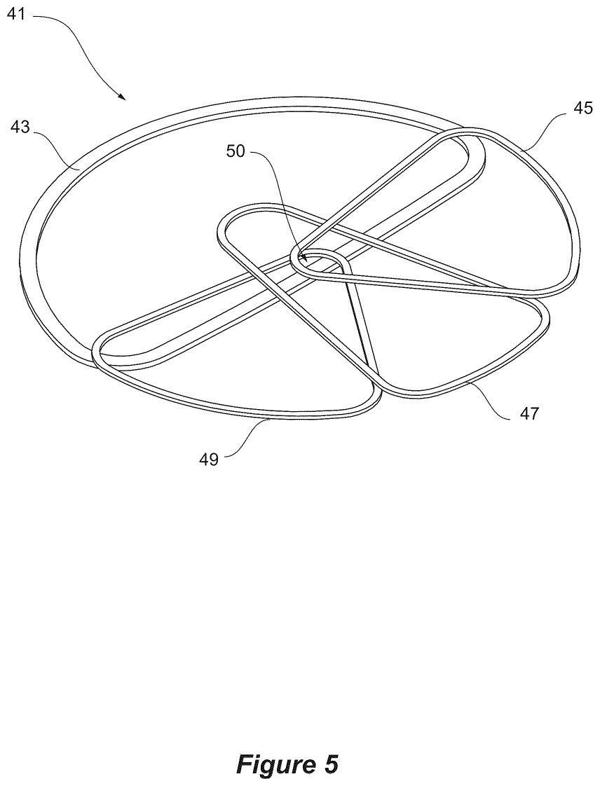

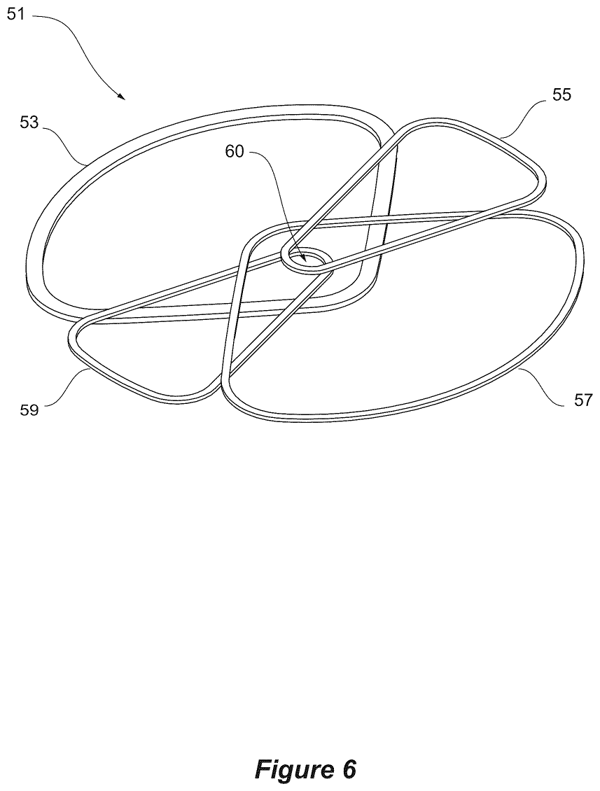

An alternative embodiment with four or more windings can be arranged as shown in FIGS. 5 and 6. In this embodiment, the four windings are arranged such that there exists at least one point in the plane of the windings that is surrounded by all windings. For example, for coil 41, windings 43, 45, 47, 49 all share a common point 50, while for coil 51, windings 53, 55, 57, 59 all share a common point 60.

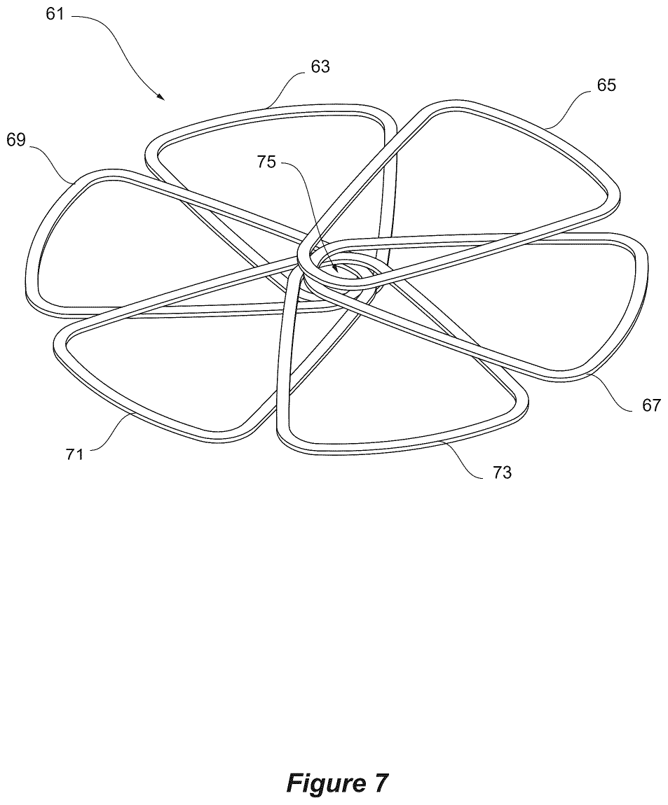

Any number of additional windings may be geometrically mutually nulled in a similar fashion. with an example shown in FIG. 7. FIG. 7 shows a coil 61 with six windings 63, 65, 67, 69, 71, 73 mutually nulled, with a common point 75 surrounded by all windings located in the centre.

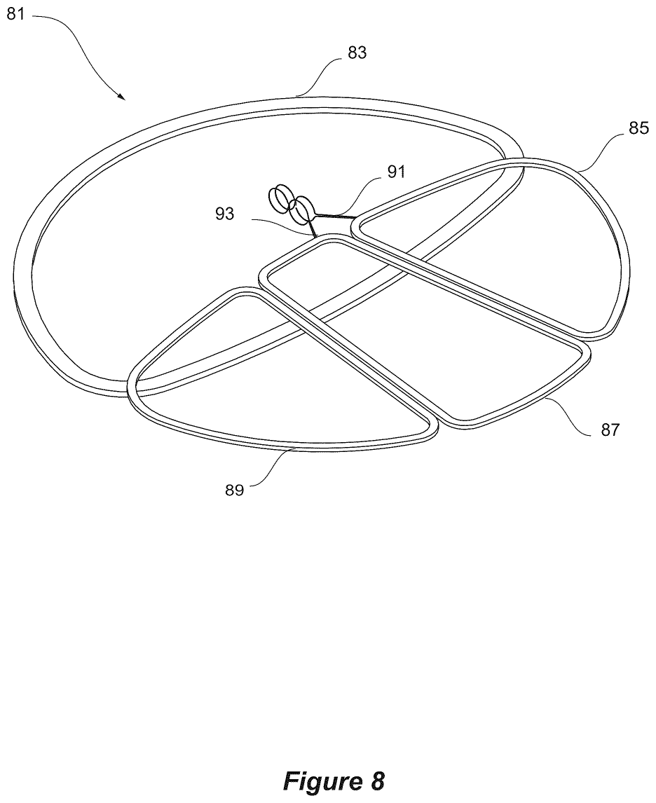

One way to cancel the magnetic crosstalk between receive windings is to use secondary or bucking windings connected electrically in series with the main receive windings to null each receive winding pair without substantially affecting the detection performance or sensitivity pattern of the winding. Due to the small size of the bucking windings in comparison to the main receive windings, the bucking windings may be used for nulling purposes without significant contribution to a received target signal. Such bucking windings may be connected in series or other suitable electrical connection arrangement. In particular, FIG. 8 uses a combination of geometric nulling and bucking winding nulling. This embodiment comprises a transmit winding 83 and three receive windings 85, 87, 89. All windings 83, 85, 87, 89 are located substantially in the same plane. Each of receive windings 85, 87, 89 forms part of a separate receive circuit. For receive windings 85 and 87, their receive circuit includes bucking windings 91 and 93, respectively. The receive windings 85, 87, 89 are geometrically nulled with respect to the transmit winding 83. The receive windings 85, 87, 89 are not geometrically nulled to each other, and in the positions shown have strong mutual coupling. To null the receive winding pairs, additional figure-8 bucking windings 91 and 93 are connected in series with the main receive windings 85, 87. Bucking windings 91 and 93 are positioned in close proximity to each other such that they have strong mutual coupling that is equal and opposite to that between windings 85 and 87. When connected in series, the net mutual inductance between the receive circuits formed by windings 85 and 91, and windings 87 and 93 is zero. It should be noted that FIG. 8 has been simplified, with the bucking windings required for nulling windings 87, 89 and 85, 89 omitted for clarity. In this case, the bucking windings 91, 93 are arranged in a plane orthogonal to the main windings, such that their interaction with the environment or other windings is minimised. The use of figure-8 nulling loops for bucking windings 91, 93 further limits the influence of the nulling loops on the detection performance of the detector, by containing the magnetic fields close to the nulling loops. Figure-8 loops are also able to be tightly magnetically coupled, such that the size and number of turns required to cancel the mutual inductance of the main windings is low. This is important for a handheld detector application, to minimise the size and weight of the coil assembly.

It should be appreciated that transmit or receive windings can take many forms. In the figures and descriptions herein, the windings are shown as compact bundles in convex loops. However, the invention is not restricted to such geometries, as non-convex winding geometries or distributed windings can also be used. Additionally, this invention does not specify the manufacturing method for the coils or windings. There are many suitable winding manufacturing methods, including but not limited to wire-wound windings, windings formed as tracks on a printed circuit board, printed conductive inks. Additionally, there are many suitable coil assembly manufacturing methods that may include the use of moulded plastic housings and adhesives such as epoxy.

With reference to embodiments shown in FIGS. 2 to 8, it may be observed that three-winding arrangements may be geometrically induction balanced by locating the windings in a triangular formation, such that each pair of windings overlaps by the required amount to achieve induction balance. Four-winding arrangements may take at least two forms. In the first form, a central winding is surrounded by the other three windings, with broadly radial overlap between the central winding and the other three, and broadly tangential overlap between the outer three windings. In the second form, all four windings encircle at least one common point on the plane of the windings. Winding arrangements with five or more windings may be achieved using a similar method, where all windings encircle a common point in the plane of the windings.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

Please note that the following claims are provisional claims only and are provided as examples of possible claims and are not intended to limit the scope of what may be claimed in any future patent applications based on the present application. Integers may be added to or omitted from the example claims at a later date so as to further define or re-define the invention.

1. A coil of a handheld metal detector, comprising:
at least three windings, comprising at least one transmit winding and at least one receive winding, the at least one transmit winding for transmitting a transmit magnetic field; and the at least one receive winding for receiving a receive magnetic field;
wherein the at least three windings are configured and arranged such that primary planes of each of the at least three windings are substantially co-planar, the at least three windings are electrically separated, and the at least three windings are inductively balanced to one another.

2. The coil according to claim 1, wherein the at least one receive winding comprises a multi-turn monoloop winding, with the multi-turn monoloop winding occupying at least 90% of the at least one receive winding in terms of coil area.

3. The coil according to claim 1, wherein a main lobe of a magnetic field pattern of the at least one receive winding decreases less rapidly than or equal to a third power of a distance along an axis normal to a plane of the at least one receive winding at a distance equal to a size of a largest dimension of the at least one receive winding.

4. The coil according to claim 1, wherein each of the at least three windings is configured and arranged such that magnetic crosstalk between any two of the at least three windings is minimised to <10%.

5. The coil according to claim 1, wherein each of the at least three windings overlaps with each of the other windings.

6. The coil according to claim 1, wherein all of the at least three windings encircle a common point.

7. The coil according to claim 1, wherein each of two of the at least three windings has a bucking winding connected in series, and the bucking windings are coupled to each other.

8. The coil according to claim 7, wherein the bucking windings are figure-8 windings.

9. The coil according to claim 1, wherein the outer perimeters of the at least three windings form a substantially circular or elliptical shape.

10. The coil according to claim 1, wherein the at least three windings comprise multiple receive windings and one transmit winding.

11. The coil according to claim 1, wherein the at least three windings comprise one receive winding and multiple transmit windings.

12. The coil according to claim 11, wherein the multiple transmit windings are transmitting different transmit waveforms.

13. The coil according to claim 12, wherein the different transmit waveforms differ in their spectral content.

14. The coil according to claim 12, wherein the different transmit waveforms are transmitted at different times.

15. The coil according to claim 1, wherein a combined height of the at least three windings is less than 50 mm.

16. A handheld metal detector comprising a sensor head housing the coil of claim 1.
